(19) United States
(12) Patent Application Publication
(10) Pub. No.: US 2026/0187541 A1
(43) Pub. Date: Jul. 2, 2026

(54) METHOD FOR HYBRID THINKING MODEL DISTILLATION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yuchen Li, Beijing (CN); Yu Wang, Beijing (CN); Xinran Chen, Beijing (CN); Rui Kong, Beijing (CN); Qiyang Li, Beijing (CN); Hengyi Cai, Beijing (CN); Shuaiqiang Wang, Beijing (CN); Daiting Shi, Beijing (CN); Dawei Yin, Beijing (CN)

(73) Assignee: BEIJING BAIDU NETCOM SCIENCE TECHNOLOGY CO., LTD., Beijing (CN)

(21) Appl. No.: 19/548,629

(22) Filed: Feb. 24, 2026

(30) Foreign Application Priority Data
Dec. 24, 2025 (CN) 202511971625.7

(51) Int. Cl. G06N 20/00

(52) U.S. Cl. CPC G06N 20/00

(57) ABSTRACT

A method for hybrid thinking model distillation, including: adjusting, based on training progress, a data ratio between thinking mode data and non-thinking mode data in training data; obtaining, based on adjusted training data, a first output sequence generated by a teacher model in the non-thinking mode and a second output sequence generated by the teacher model in the thinking mode; obtaining, based on the adjusted training data, a third output sequence generated by a student model in the non-thinking mode and a fourth output sequence generated by the student model in the thinking mode; and training the student model based on the first output sequence, the second output sequence, the third output sequence, and the fourth output sequence.

### CROSS-REFERENCE TO RELATED APPLICATION

The present application is based upon and claims priority to Chinese Patent Application No. 2025119716257, filed on Dec. 24, 2025, the entire contents of which are incorporated herein by reference.

### TECHNICAL FIELD

The disclosure relates to the field of data processing, and in particular to artificial intelligence (AI) fields such as natural language processing (NLP) and deep learning (DL), and in particular to a method and an apparatus for hybrid thinking model distillation, a method and an apparatus for information processing, and an electronic device.

### BACKGROUND

In related art, to replicate reasoning capabilities of large models in small models, knowledge distillation is typically employed. A large language model (LLM) is used as a teacher model and reasoning capabilities are transferred to a student model via supervision of a generation processes or supervision of a final answer.

### SUMMARY

In a first aspect, embodiments of the disclosure provide a method for hybrid thinking model distillation. The method includes: adjusting, based on training progress, a data ratio between thinking mode data and non-thinking mode data in training data; obtaining, based on adjusted training data, a first output sequence generated by a teacher model in the non-thinking mode and a second output sequence generated by the teacher model in the thinking mode; obtaining, based on the adjusted training data, a third output sequence generated by a student model in the non-thinking mode and a fourth output sequence generated by the student model in the thinking mode; and training the student model based on the first output sequence, the second output sequence, the third output sequence, and the fourth output sequence.

In a second aspect, embodiments of the disclosure provide an electronic device The electronic device includes: at least one processor; and a memory communicatively connected to the at least one processor, in which the memory stores instructions executable by the at least one processor, and the instructions are executed by the at least one processor to cause the at least one processor to perform the method according to the first aspect.

In a third aspect, embodiments of the disclosure provide a non-transitory computer-readable storage medium. The storage medium stores computer instructions, in which the computer instructions are configured to cause the computer to perform the method according to the first aspect.

### BRIEF DESCRIPTION OF THE DRAWINGS

The accompanying drawings are used for a better understanding of the disclosure and do not constitute a limitation of the disclosure.

FIG. 1 is a flowchart illustrating a method for hybrid thinking model distillation according to an embodiment of the disclosure.

FIG. 2 is a flowchart illustrating a method for hybrid thinking model distillation according to an embodiment of the disclosure.

FIG. 3 is a schematic diagram illustrating scheduling of thinking mode data according to an embodiment of the disclosure.

FIG. 4 is a flowchart illustrating a method for information processing according to an embodiment of the disclosure.

FIG. 5 is a block diagram illustrating an apparatus for hybrid thinking model distillation according to an embodiment of the disclosure.

FIG. 6 is a block diagram illustrating an apparatus for information processing according to an embodiment of the disclosure.

FIG. 7 is a block diagram illustrating an electronic device according to an embodiment of the disclosure.

### DETAILED DESCRIPTION

The following description of the exemplary embodiments of the disclosure is made in conjunction with the accompanying drawings, including various details of the embodiments to aid understanding. These details should be considered merely exemplary. Thus, those skilled in the art should recognize that various modifications and alterations may be made to the embodiments described herein without departing from the scope and spirit of the disclosure. Similarly, for clarity and brevity, descriptions of well-known functions and structures are omitted in the following description.

Embodiments of the disclosure relate to technical fields of artificial intelligence (AI) such as natural language processing (NLP), large models, deep learning (DL), and hybrid thinking models.

AI is a new technical science that studies and develops theories, methods, technologies, and application systems for simulating, extending, and expanding human intelligence.

NLP is an important direction in the fields of computer science and AI. The NLP studies various theories and methods that enable effective communication between humans and computers using natural language. The NLP is a discipline that takes language as an object, utilizes computer technology to analyze, understand, and process natural language. That is, the NLP uses the computer as a powerful tool for language research, conducts quantitative research on linguistic information with the support of computers, and provides linguistic descriptions that can be shared and used by humans and computers.

A large language model (LLM, also called a large model) refers to a deep learning model trained on a large amount of text data, which may generate natural language text or understand the meaning of language text. The LLM may handle various natural language tasks, such as text classification, question answering, and dialogue, and represent an important path toward AI.

The DL involves learning inherent laws and representational hierarchies of sample data. The information obtained during learning processes is highly helpful for interpreting data such as text, images, and sound. The ultimate goal of the deep learning is to enable machines to possess analytical learning capabilities similar to humans, allowing the machines to recognize data such as text, images, sound, and the like.

A hybrid thinking model may be understood as a model with hybrid thinking modes, meaning the model possesses two reasoning approaches simultaneously: a thinking mode and a non-thinking mode. This enables the model to output complete chain-of-thought (COT) in complex reasoning tasks and provide direct answers quickly for simple tasks, thus achieving flexible switching between reasoning depth and reasoning efficiency.

It should be noted that in the technical solutions of the disclosure, processing including collection, storage, use, shaping, transmission, provision and disclosure of personal information of a user is performed with the consent of the user, and is in compliance with the provisions of relevant laws and regulations, and does not violate public order and moral.

It should be noted that in the embodiments of the disclosure, some software, components, models, and other existing solutions in the industry may be mentioned, which should be considered as exemplary. The purpose is only to illustrate a feasibility of the technical solution in the application, but it does not mean that the applicant has already or necessarily used the solution.

A method and an apparatus for hybrid thinking model distillation, a method and an apparatus for information processing, and an electronic device according to the embodiments of the disclosure are described below with reference to the accompanying drawings.

It should be noted that an execution entity of the method for hybrid thinking model distillation in the embodiments of the disclosure may be an apparatus for hybrid thinking model distillation. The apparatus may be implemented by software and/or hardware, and may be configured in an electronic device. The electronic device may include, but is not limited to, a terminal, a server, and the like.

It should be noted that an execution entity of the method for information processing in the embodiments of the disclosure may be an apparatus for information processing. The apparatus may be implemented by software and/or hardware, and may be configured in an electronic device. The electronic device may include, but is not limited to, a terminal, a server, and the like.

FIG. 1 is a flowchart illustrating a method for hybrid thinking model distillation according to an embodiment of the disclosure. As shown in FIG. 1, the method for hybrid thinking model distillation may include, but is not limited to, the following steps 101 to 104.

At step 101, a data ratio between thinking mode data and non-thinking mode data in training data is adjusted based on training progress.

In the embodiment of the disclosure, the thinking mode data may be used to train a COT reasoning capability of a model in a thinking mode, and the non-thinking mode data may be used to train a direct answering capability of a model in a non-thinking mode. For example, the thinking mode data may include, but is not limited to, COT data, and the non-thinking mode data may include direct answer data without a reasoning chain.

In some embodiments, in a distillation task for a large hybrid thinking mode model (also called a hybrid thinking model), the large hybrid thinking mode model is used as a teacher model. The teacher model possesses two output forms a thinking mode and a non-thinking mode, corresponding to COT reasoning and direct answering respectively. To effectively transfer the two types of capabilities from the teacher model to a student model, it is necessary to handle both types of output distributions simultaneously. For example, training data including the thinking mode data and the non-thinking mode data may be utilized to transfer knowledge from the teacher model to a smaller student model, enabling the student model to also possess two output forms: the thinking mode and the non-thinking mode.

In some embodiments, during an entire training process, the data ratio between the thinking mode data and the non-thinking mode data in the training data may be adjusted based on the training progress. A ratio of a current training step to a total number of training steps may be used as the training progress. For example, assuming the total number of training steps is T and the current training step is t, the ratio of the current training step to the total number of training steps may be used as the training progress. That is, the training progress at the t-th training step is represented using a normalized form sₜ=t/T.

For example, in each training step t, the data ratio between the thinking mode data and the non-thinking mode data in the training data to be used in the training step t may be dynamically adjusted based on the training progress of the training step t. That is, embodiments of the disclosure may dynamically control the data ratio between the thinking mode data and the non-thinking mode data in the training data based on the training step, enabling adaptive balancing of the proportion of the thinking mode data and the non-thinking mode data during the training process.

At step 102, a first output sequence generated by a teacher model in the non-thinking mode and a second output sequence generated by the teacher model in the thinking mode are obtained based on adjusted training data.

In the embodiment of the disclosure, the training data obtained after adjusting the data ratio may be input into the teacher model to obtain the first output sequence generated by the teacher model in the non-thinking mode, and further to obtain the second output sequence generated by the teacher model in the thinking mode. The first output sequence generated in the non-thinking mode may be direct answer logits without a COT, and the second output sequence generated in the thinking mode may be logits including a COT. The logits may refer to raw output values at a final layer (typically a fully connected layer) of the model, which have not undergone normalization processing.

At step 103, a third output sequence generated by a student model in the non-thinking mode and a fourth output sequence generated by the student model in the thinking mode are obtained based on the adjusted training data.

In the embodiment of the disclosure, the training data obtained after adjusting the data ratio may be input into the student model to obtain the third output sequence generated by the student model in the non-thinking mode, and further to obtain the fourth output sequence generated by the student model in the thinking mode. The third output sequence generated in the non-thinking mode may be direct answer logits without a COT, and the fourth output sequence generated in the thinking mode may be logits including a COT.

It should be noted that, in some embodiments, the execution order of step 102 and step 103 may be exchanged, or may be executed simultaneously.

At step 104, the student model is trained based on the first output sequence, the second output sequence, the third output sequence, and the fourth output sequence.

In the embodiment of the disclosure, based on the first output sequence, the second output sequence, the third output sequence, and the fourth output sequence, the student model is trained using an online distillation approach. The online distillation approach differs from traditional offline distillation. The traditional offline distillation involves the teacher model generating sequences in advance for the student model to learn. The online distillation approach may be understood as letting the student model generate sequences, with the teacher model providing corrections. That is, using the training data obtained after adjusting the data ratio as input, the student model may generate the fourth output sequence in the thinking mode and the third output sequence in the non-thinking mode, and the teacher model evaluates the generation results of the student model.

By implementing the embodiments of the disclosure, performance of the model in dual modes (including the thinking mode and the non-thinking mode) may be significantly improved, enabling simultaneous enhancement of capabilities in both the thinking mode and the non-thinking mode, thus avoiding the problem in traditional knowledge distillation where “improvement in one capability leads to a decline in the other”. For products requiring various tasks such as instant Q&A, real-time dialogue, logical reasoning, and knowledge-based problem-solving, this coordinated enhancement of dual modes may significantly expand coverage capability of a system, enabling it to maintain stable and reliable output quality across a wide range of tasks.

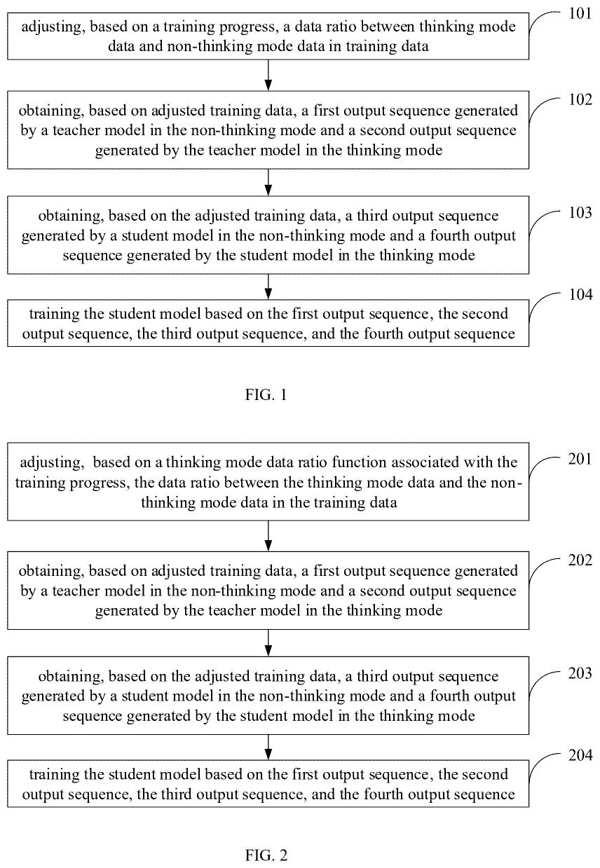

FIG. 2 is a flowchart illustrating a method for hybrid thinking model distillation according to an embodiment of the disclosure. As shown in FIG. 2, the method for hybrid thinking model distillation may include, but is not limited to, the following steps 201 to 204.

At step 201, a data ratio between thinking mode data and non-thinking mode data in training data is adjusted based on a thinking mode data ratio function associated with training progress.

In the embodiment of the disclosure, a ratio of a current training step to a total number of training steps may be used as the training progress. For example, assuming the total number of training steps is T and the current training step is t, the ratio of the current training step to the total number of training steps may be used as the training progress. That is, the training progress at the t-th training step is represented using a normalized form sₜ=t/T. The disclosure introduces a ratio function associated with the training progress for dynamically adjusting a proportion of the thinking mode data in the training data. For example, the thinking mode data ratio function may be denoted by r(sₜ). It may be seen that the data ratio of the thinking mode data dynamically changes with a variation of the training progress of training step t. For example, for each training step, the thinking mode data ratio function may be utilized to adjust the data ratio between thinking mode data and non-thinking mode data in the training data to be used in the training step. For example, for the training progress at step t, the thinking mode data ratio function may be used to determine that the proportion of thinking mode data at step t is A1. Based on the proportion, the proportion of the thinking mode data in the training data to be used at step t may be adjusted to A1, and the proportion of the non-thinking mode data in the training data may be adjusted to 1-A1.

In some embodiments, the thinking mode data ratio function may be an S-shaped function with an output value range between (0, 1). In a possible implementation, the thinking mode data ratio function may be constructed based on a Sigmoid function, but is not limited herein. For example, the thinking mode data ratio function may also be based on a hyperbolic tangent function (Tanh), etc.

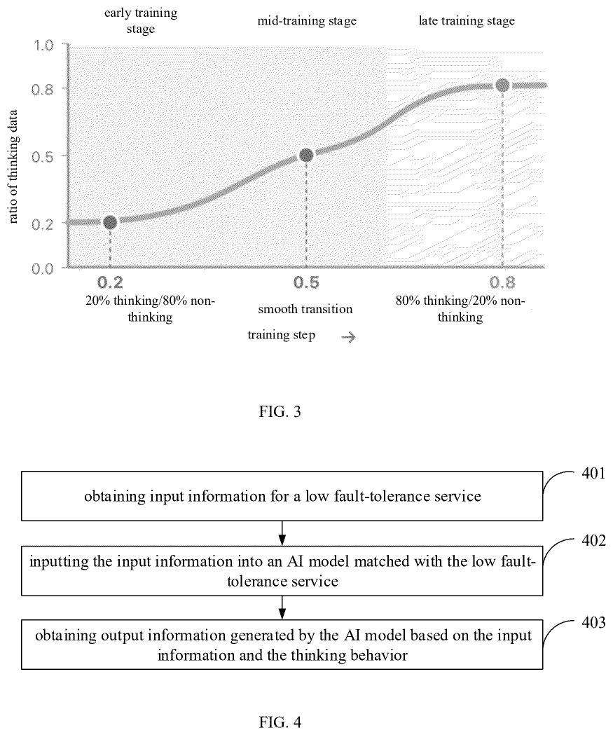

For example, as shown in FIG. 3, it is a schematic diagram illustrating scheduling of the thinking mode data (also referred to as thinking data). FIG. 3 illustrates how the proportion of thinking mode data is scheduled based on the number of training steps. The proportion of the thinking mode data may remain close to a first value (e.g., 0.2) in early stages of training and approach a second value (e.g., 0.8) in later stages of training. Through a smooth thinking mode data ratio function (for example, an S-shaped function with an output value range between (0, 1), such as a Sigmoid function), the model training transitions gradually from “predominantly non-thinking” to “predominantly thinking” as the training steps progress. A reason for employing the S-shaped function with an output value range between (0, 1) lies in its characteristics of being continuous, smooth, and having a controllable slope, which enable it to effectively fit the “Pareto principle (80/20 Rule)” and exhibit an optimal performance point. The data scheduling mechanism constructed in this way may provide the most suitable capability training data for each training phase (e.g., early, middle, and late stages of training), avoiding the problem of asynchronous dual-mode learning caused by a fixed ratio.

At step 202, a first output sequence generated by a teacher model in the non-thinking mode and a second output sequence generated by the teacher model in the thinking mode are obtained based on adjusted training data.

In the embodiments of the disclosure, step 202 may be implemented in any manner described in the various embodiments of the disclosure. The embodiments of the disclosure do not impose limitations on this and will not elaborate further.

At step 203, a third output sequence generated by a student model in the non-thinking mode and a fourth output sequence generated by the student model in the thinking mode are obtained based on the adjusted training data.

In the embodiments of the disclosure, step 203 may be implemented in any manner described in the various embodiments of the disclosure. The embodiments of the disclosure do not impose limitations on this and will not elaborate further.

It should be noted that, in some embodiments, the execution order of step 202 and step 203 may be exchanged, or may be executed simultaneously.

At step 204, the student model is trained based on the first output sequence, the second output sequence, the third output sequence, and the fourth output sequence.

In some embodiments, a token-level knowledge distillation loss in the non-thinking mode may be determined based on the first output sequence generated by the teacher model in the non-thinking mode and the third output sequence generated by the student model in the non-thinking mode. A token-level supervision loss in the thinking mode may be determined based on the second output sequence generated by the teacher model in the thinking mode and the fourth output sequence generated by the student model in the thinking mode. A total loss is determined based on the token-level knowledge distillation loss and the token-level supervision loss, and the student model is trained based on the total loss, that is, backpropagation is performed according to the total loss to update parameters of the student model.

In some embodiments, the total loss may be obtained by performing a weighted summation of the token-level knowledge distillation loss and the token-level supervision loss. A weight of the token-level knowledge distillation loss and a weight of the token-level supervision loss may be determined based on the thinking mode data ratio function. For example, the thinking mode data ratio function may be an S-shaped function with an output value range between (0, 1). For example, the thinking mode data ratio function may be constructed based on a Sigmoid function.

It should be noted that, in the embodiments of the disclosure, regarding loss function modeling, the non-thinking mode may employ a standard token-level knowledge distillation loss. That is, a Kullback-Leibler (KL) divergence (also known as relative entropy) is calculated and accumulated between a non-thinking output distribution of the teacher model and a non-thinking output distribution of the student model. For the thinking mode, the KL divergence may be similarly employed to supervise each token in the COT reasoning sequence. The total loss for an entire training step is a weighted sum of a thinking mode loss and a non-thinking mode loss. For example, taking the total loss for a certain training step as an example: total loss for the training step=w1*non-thinking mode loss+w2*thinking mode loss. In this case, the non-thinking mode loss is: an accumulated value of the KL divergence calculated using the non-thinking output distribution of the teacher model and the non-thinking output distribution of the student model. The thinking mode loss is: the KL divergence calculated for each token in the thinking output distribution of the teacher model and a corresponding token in the thinking output distribution of the student model. w1 and w2 are weights respectively. Weight w2 for the thinking mode loss is precisely the dynamically changing thinking mode data ratio function r(sₜ). This means that in the early stages of training, the main optimization direction of the model leans towards the non-thinking mode. As training gradually progresses to later stages, the weight of the thinking mode in the loss gradually increases, giving the model more opportunities to learn a reasoning chain structure. The final overall training objective is to minimize an expected loss across all training steps.

The inventor of the method for hybrid thinking model distillation provided in the disclosure found via experiments that if the proportion r(sₜ) of thinking mode data is fixed at 0, meaning the training data comes solely from the non-thinking mode data, thinking capability declines significantly. If the proportion r(sₜ) of the thinking mode data is fixed at 1, the thinking mode may be improved but enhancement of non-thinking capability is limited. If the proportion r(sₜ) of thinking mode data is directly fixed at 0.2 or 0.8, the model only performs well in capability at one end. However, by allowing r(sₜ) to change dynamically with the training progress of the training steps, the model may quickly fit the non-thinking mode in the early phase and fully learn the thinking mode in the later phase, thus achieving simultaneous enhancement of both types of capabilities. Experiments show that this dynamic scheduling method brings an average improvement of approximately 1.85% in the non-thinking mode and an improvement of approximately 0.23% in the thinking mode, effectively breaking through the performance trade-off (referring to the balancing of different objectives or resources in complex decision-making) present in fixed-ratio distillation.

In the above embodiments, by dynamically adjusting the proportion of the thinking mode data and the non-thinking mode data in the training data to be used for each training step based on the thinking mode data ratio function associated with the training progress, the proportion of thinking mode data and non-thinking mode data may be adaptively balanced during the training process. This enables synchronous enhancement of the thinking mode and the non-thinking mode, allowing the model to obtain stronger logical reasoning capability and process stability while maintaining efficient reasoning speed.

FIG. 4 is a flowchart illustrating a method for information processing according to an embodiment of the disclosure. As shown in FIG. 4, the method for information processing may include, but is not limited to, the following steps 401 to 403.

At step 401, input information for a low fault-tolerance service is obtained.

In some embodiments, the low fault-tolerance service may be a service related to industries such as finance, healthcare, or law, or a service related to security review, content compliance detection, and the like. For example, an AI model corresponding to the low fault-tolerance service may be provided to users. The users may utilize the AI model to perform processing related to the low fault-tolerance service. For example, a user may input information related to the low fault-tolerance service, and the AI model may perform corresponding processing on user input information. The AI model may be a model trained based on the method for hybrid thinking model distillation described in the above method embodiments. The AI model may be a small model that simultaneously includes a thinking mode and a non-thinking mode.

For example, taking the low fault-tolerance service as a legal consultation service, the user consults via the AI model for legal advice. The AI model may determine whether to generate a non-thinking mode output result or a thinking mode output result based on a complexity of the user input information.

At step 402, the input information is input into an AI model matched with the low fault-tolerance service.

The AI model may determine a thinking behavior based on the input information. That is, the AI model may determine the thinking behavior based on the complexity of the user input information. The thinking behavior may be in the thinking mode or in the non-thinking mode.

For example, if the user input information is a simple task, the AI model may generate a non-thinking mode output result, that is, an output result that is a direct answer without a COT. For example, if the user input information is a complex task, the AI model may generate a thinking mode output result, that is, an output result that includes a COT.

At step 403, output information generated by the AI model based on the input information and the thinking behavior is obtained.

In the above embodiments, by using the method for hybrid thinking model distillation provided in the disclosure to train the AI model, performance of the AI model in dual modes (including a thinking mode and a non-thinking mode) can be improved, enabling simultaneous enhancement of capabilities in both the thinking mode and the non-thinking mode. Applying the AI model to low fault-tolerance service scenarios may significantly enhance interpretability and professional credibility of a product, and improve reliability in industry applications.

It should be noted that the method for hybrid thinking model distillation provided the disclosure exhibits good universality and extensibility. The specific application processes and examples in various fields are detailed below.

### 1. Small Model Distillation Scenarios for Large Hybrid Thinking Mode Language Models

The disclosure may be directly applied in distillation training for migrating from large models to small models, and is particularly suitable for hybrid reasoning models that simultaneously include a thinking mode and a non-thinking mode. In these scenarios, a student model typically has a smaller number of parameters, making the student model difficult to simultaneously learn deep reasoning chains and efficient short-answer capabilities. Through a dynamic data ratio scheduling mechanism, the disclosure enables the student model to quickly master concise answering patterns in the early stages of training and gradually learn reasoning chain structures in the later stages, thus obtaining dual-mode capabilities.

For scenarios with high simultaneous requirements for speed and accuracy, such as mobile devices or large-scale enterprise-deployed internal models, the disclosure may significantly reduce training costs and reasoning costs of the student model. The disclosure avoids problems in traditional knowledge distillation such as “a decline in reasoning capability” or “difficulty in compressing lengthy chains,” enabling small models to maintain high reasoning quality while achieving higher response efficiency, thus meeting practical application needs under different reasoning depths.

### 2. Training Processes for Large Models Possessing COT Reasoning Capability or Explicit COT

In tasks requiring models to output in interpretable reasoning structures, such as mathematical reasoning, legal logic analysis, engineering planning, and the like, the reasoning chain capability of student models may be effectively maintained in the disclosure. Traditional distillation modes often cause the student model to lose reasoning chain structures. The dynamic scheduling strategy using an S-shaped function (e.g., a Sigmoid function) in the disclosure strengthens the thinking mode data in the later stages of training, enabling the student model to fully learn reasoning chains while maintaining output stability and interpretability.

Through application of the disclosure, high accuracy is maintained in COT reasoning tasks, and phenomena such as breakage, redundancy, or excessive brevity is prevented when the model generates COT reasoning. This mechanism is particularly important for industry applications requiring strict logical consistency, such as financial audit reasoning, generation of reasoning paths for compliance models, and generation of mathematical problem-solving processes, endowing the model with higher reliability.

### 3. Multi-Strategy Reasoning Frameworks Require a Combination of a Thinking Mode and a Non-Thinking Mode

In large model frameworks with multi-path reasoning structures, such as systems that intelligently select between the thinking mode and the non-thinking mode based on task complexity, the disclosure may significantly improve stability of model switching between different reasoning strategies. Due to consistent data ratios during training, traditional models often have a weaker performance in one mode, leading to instability or performance collapse when switching reasoning strategies. By dynamically scheduling training data, the disclosure ensures the model performs well in both modes, thus enhancing overall robustness of the reasoning system.

This solution is particularly critical for complex systems actually deployed in search engines, intelligent assistants, and Q&A platforms. The system may quickly answer routine questions via a lightweight mode and activate the thinking mode when facing complex tasks such as mathematics or logic. Both modes have been fully trained within the model through the algorithm of the disclosure, enabling the system to maintain high performance and consistency across different reasoning paths.

### 4. Training High-Reliability Hybrid Thinking Models for Industries Such as Finance, Healthcare, Law, and the Like

In some industries, models are required to possess both “fast and accurate short-answer capability” and “interpretable, auditable deep reasoning capability.” The dynamic data scheduling mechanism provided in the disclosure may simultaneously meet the two types of requirements. For example, in financial risk control, a system needs to quickly output preliminary conclusions while providing complete reasoning chains during risk assessment. The disclosure may help build industry models possessing both types of capabilities.

In tasks such as medical consultation, legal judgment, audit analysis, and planning decision-making, the disclosure may be used to construct models with dual-mode reasoning capability, enabling the models to quickly answer routine queries while performing deep reasoning capability in complex cases, interpretation of legal provisions, and decision analysis. In the demanding fields, the ability of the disclosure to improve reasoning stability and reduce mode-switching risks not only enhances model performance but also significantly improves safety and reliability of industry applications.

### 5. Application in Secure Reasoning, Review, and High-Trust Explanation Chain Generation Models

In security reviews, content compliance detection, and self-checking and reflection mechanisms for agent models, models need to possess both “fast judgment” and “deep argumentation” capabilities. By dynamically scheduling the thinking mode data/non-thinking mode data during training, the disclosure enables the student model to quickly complete classification or determination while also outputting detailed, credible reasoning chains when necessary, providing transparent, traceable justifications for security review tasks.

This solution may support security-related tasks such as secure reasoning explanation chains, traceability of non-compliant content, automated agent review, and the like. This solution enables models to maintain stable and rigorous reasoning structures when facing high-risk inputs while ensuring high efficiency in large-scale applications. For large model systems that need to balance cost, performance, and security, the disclosure provides a highly reliable training solution that is directly implemented.

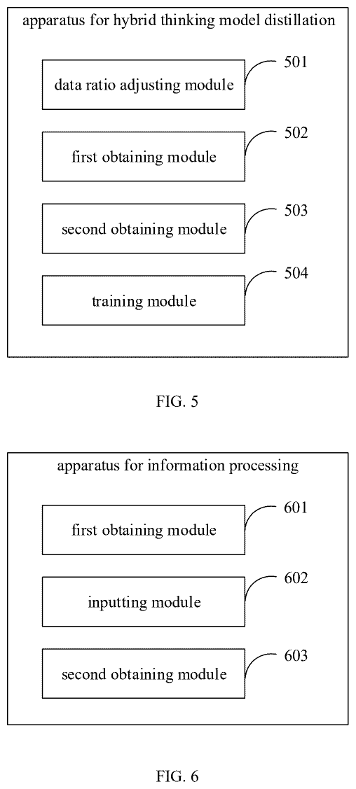

FIG. 5 is a block diagram illustrating an apparatus for hybrid thinking model distillation according to an embodiment of the disclosure. As shown in FIG. 5, the apparatus for hybrid thinking model distillation may include: a data ratio adjusting module 501, a first obtaining module 502, a second obtaining module 503, and a training module 504.

The data ratio adjusting module 501 is configured to adjust, based on training progress, a data ratio between thinking mode data and non-thinking mode data in training data.

The first obtaining module 502 is configured to obtain, based on adjusted training data, a first output sequence generated by a teacher model in the non-thinking mode and a second output sequence generated by the teacher model in the thinking mode.

The second obtaining module 503 is configured to obtain, based on the adjusted training data, a third output sequence generated by a student model in the non-thinking mode and a fourth output sequence generated by the student model in the thinking mode.

The training module 504 is configured to train the student model based on the first output sequence, the second output sequence, the third output sequence, and the fourth output sequence.

In some embodiments, the data ratio adjusting module 501 is configured to: adjust, based on a thinking mode data ratio function associated with the training progress, the data ratio between the thinking mode data and the non-thinking mode data in the training data, in which a ratio of a current training step to a total number of training steps is determined as the training progress.

In some embodiments, the training module 504 is configured to: determine, based on the first output sequence and the third output sequence, a token-level knowledge distillation loss in the non-thinking mode; determine, based on the second output sequence and the fourth output sequence, a token-level supervision loss in the thinking mode; and determine a total loss based on the token-level knowledge distillation loss and the token-level supervision loss, and train the student model based on the total loss.

In some embodiments, the training module 504 is configured to: obtain the total loss by performing a weighted summation of the token-level knowledge distillation loss and the token-level supervision loss, in which a weight of the token-level knowledge distillation loss and a weight of the token-level supervision loss are determined based on the thinking mode data ratio function.

In some embodiments, the thinking mode data ratio function is an S-shaped function with an output value range between (0, 1). In a possible implementation, the thinking mode data ratio function is constructed based on a Sigmoid function.

Regarding the apparatus in the above embodiments, the specific manners in which the respective modules perform operations have been described in detail in the embodiments related to the method, and will not be elaborated here.

FIG. 6 is a block diagram illustrating an apparatus for information processing according to an embodiment of the disclosure. As shown in FIG. 6, the apparatus for information processing may include: a first obtaining module 601, an inputting module 602, and a second obtaining module 603.

The first obtaining module 601 is configured to obtain input information for a low fault-tolerance service.

The inputting module 602 is configured to inputting the input information into an AI model matched with the low fault-tolerance service, in which the AI model determines a thinking behavior based on the input information, and the AI model is a model trained based on the method for hybrid thinking model distillation.

The second obtaining module 603 is configured to obtain output information generated by the AI model based on the input information and the thinking behavior.

Regarding the apparatus in the above embodiments, the specific manners in which the respective modules perform operations have been described in detail in the embodiments related to the method, and will not be elaborated here.

According to the embodiments of the disclosure, the disclosure also provides an electronic device, and a readable storage medium.

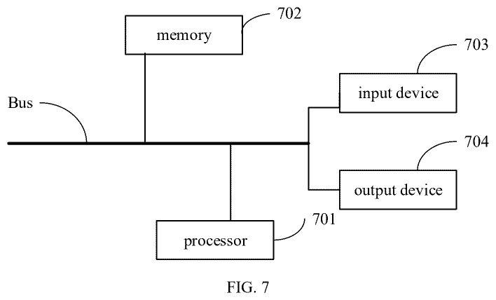

FIG. 7 is a block diagram illustrating an electronic device according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 7, the electronic device includes one or more processors 701, a memory 702, and interfaces for connecting various components, including high-speed interfaces and low-speed interfaces. The various components are connected to each other via different buses, and may be installed on a common motherboard or installed in other ways as required. The processor 701 may process instructions executed in the electronic device, including instructions stored in or on the memory 702 to display graphical information of a graphic user interface (GUI) on an external input/output device (such as a display device coupled to an interface). In other embodiments, when necessary, a plurality of processors and/or a plurality of buses may be used with a plurality of memories. Similarly, a plurality of electronic devices may be connected, and each device provides some necessary operations (for example, as a server array, a group of blade servers, or a multi-processor system). In FIG. 7, a processor 701 is taken as an example.

The memory 702 is a non-transitory computer-readable storage medium according to the disclosure. The memory stores instructions that may be implemented by at least one processor, so that at least one processor implements the method for hybrid thinking model distillation or the method for information processing according to the disclosure. The non-transitory computer-readable storage medium of the disclosure has computer instructions stored thereon, in which the computer instructions are used to cause a computer to implement the method for hybrid thinking model distillation or the method for information processing according to the disclosure.

As a non-transitory computer-readable storage medium, the memory 702 may be used to store non-transitory software programs, non-transitory computer-executable programs and modules, such as program instructions/modules (for example, the data ratio adjusting module 501, the first obtaining module 502, the second obtaining module 503, and the training module 504 shown in FIG. 5) corresponding to the method for hybrid thinking model distillation in the embodiments of the disclosure, or program instructions/modules (for example, the first obtaining module 601, the inputting module 602, and the second obtaining module 603 shown in FIG. 6) corresponding to the method for information processing in the embodiments of the disclosure. The processor 701 implements various functional applications and data processing of the server, that is, implements the method for hybrid thinking model distillation or the method for information processing in the above method embodiments, by running the non-transitory software programs, instructions, and modules stored in the memory 702.

The memory 702 may include a storage program area and a storage data area, in which the storage program area may store an operating system and at least an application program required by one function; the storage data area may store the data created by the use of the electronic device. In addition, the memory 702 may include a high-speed random access memory, and may also include a non-transitory memory, such as at least one magnetic disk storage device, a flash memory device, or other non-transitory solid-state storage devices. In some embodiments, the memory 702 may optionally include memories remotely provided relative to the processor 701, and these remote memories may be connected to the electronic device. Examples of the above networks include, but are not limited to, the Internet, a corporate Intranet, a local area network, a mobile communication network, and combinations thereof.

The electronic device may further include: an input device 703 and an output device 704. The processor 701, the memory 702, the input device 703, and the output device 704 may be connected via a bus or other methods. In FIG. 7, the connection by a bus is taken as an example.

The input device 703 may receive input numeric or character information, and generate key signal input related to user setting and function control of the electronic device, such as touch screens, keypads, mouses, trackpads, touchpads, and pointing sticks, one or more mouse buttons, trackballs, joysticks and other input devices. The output device 704 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various implementations of the systems and technologies described herein may be implemented in digital electronic circuit systems, integrated circuit systems, application-specific integrated circuits (ASICs), computer hardware, firmware, software, and/or combinations thereof. These various implementation methods may be implemented in one or more computer programs, in which the one or more computer programs may be executed and/or interpreted on a programmable system including at least one programmable processor. The programmable processor may be a dedicated or general-purpose programmable processor that may receive data and instructions from the storage system, at least one input device, and at least one output device, and transmit the data and instructions to the storage system, at least one input device, and at least one output device.

These computational procedures (also called programs, software, software applications, or codes) include machine instructions of a programmable processor, and may be implemented using high-level procedures and/or object-oriented programming languages, and/or assembly/machine language to implement computational procedures. As used herein, the terms “machine-readable medium” and “computer-readable medium” refer to any computer program product, device, and/or apparatus used to provide machine instructions and/or data to a programmable processor (for example, magnetic disks, optical disks, memories, programmable logic devices (PLDs)), including machine-readable media that receive machine instructions as machine-readable signals. The term “machine-readable signal” refers to any signal used to provide machine instructions and/or data to a programmable processor.

In order to provide interaction with the user, the systems and technologies described herein may be implemented on a computer and the computer includes a display apparatus for displaying information to the user (for example, a cathode ray tube (CRT) or a liquid crystal display (LCD) monitor); and a keyboard and a pointing apparatus (for example, a mouse or a trackball) through which the user can provide input to the computer. Other types of apparatus can also be used to provide interaction with the user; for example, the feedback provided to the user may be any form of sensory feedback (for example, visual feedback, auditory feedback, or tactile feedback); and may be in any form (including acoustic input, voice input, or tactile input) to receive input from the user.

The systems and technologies described herein may be implemented in a computing system that includes back-end components (for example, as a data server), or a computing system that includes middleware components (for example, an application server), or a computing system that includes front-end components (for example, a user computer with a graphical user interface or web browser through which the user can interact with the implementation of the systems and technologies described herein), or a computing system that includes any combination of such back-end components, middleware components, or front-end components. The components of the system may be connected to each other through any form or medium of digital data communication (for example, a communication network). Examples of communication networks include: a local area networks (LAN), a wide area networks (WAN), the Internet, and blockchain networks.

The computer system may include a client and a server. The client and server are generally far away from each other and usually interact through a communication network. A relationship between the client and the server is generated by computer programs that run on the corresponding computer and have a client-server relationship with each other. The server may be a cloud server, also known as a cloud computing server or a cloud host, which is a host product in the cloud computing service system to solve the problem of difficult management and weak service scalability of traditional physical hosts and VPS (virtual private server) services. The server can also be a server for distributed system, or a server that combines block chain.

It should be understood that the various forms of processes illustrated above may be used to reorder, add or delete actions. For example, the actions described in the disclosure may be executed in parallel, sequentially, or in a different order, as long as a desired result of the technical solution disclosed in the disclosure may be achieved, which is not limited herein.

The above specific implementations do not constitute a limitation on the protection scope of the disclosure. Those skilled in the art should understand that various modifications, combinations, sub-combinations and substitutions may be made based on design requirements and other factors. Any modification, equivalent replacement and improvement made within the spirit and principle of the disclosure shall be included in the protection scope of the disclosure.

What is claimed is:

1. A method for hybrid thinking model distillation, comprising:
adjusting, based on training progress, a data ratio between thinking mode data and non-thinking mode data in training data;
obtaining, based on adjusted training data, a first output sequence generated by a teacher model in the non-thinking mode and a second output sequence generated by the teacher model in the thinking mode;
obtaining, based on the adjusted training data, a third output sequence generated by a student model in the non-thinking mode and a fourth output sequence generated by the student model in the thinking mode; and
training the student model based on the first output sequence, the second output sequence, the third output sequence, and the fourth output sequence.

2. The method according to claim 1, wherein adjusting, based on the training progress, the data ratio between the thinking mode data and the non-thinking mode data in the training data comprises:
adjusting, based on a thinking mode data ratio function associated with the training progress, the data ratio between the thinking mode data and the non-thinking mode data in the training data, wherein a ratio of a current training step to a total number of training steps is determined as the training progress.

3. The method according to claim 1, wherein training the student model based on the first output sequence, the second output sequence, the third output sequence, and the fourth output sequence comprises:
determining, based on the first output sequence and the third output sequence, a token-level knowledge distillation loss in the non-thinking mode;
determining, based on the second output sequence and the fourth output sequence, a token-level supervision loss in the thinking mode; and
determining a total loss based on the token-level knowledge distillation loss and the token-level supervision loss, and training the student model based on the total loss.

4. The method according to claim 3, wherein determining the total loss based on the token-level knowledge distillation loss and the token-level supervision loss comprises:
obtaining the total loss by performing a weighted summation of the token-level knowledge distillation loss and the token-level supervision loss, wherein a weight of the token-level knowledge distillation loss and a weight of the token-level supervision loss are determined based on a thinking mode data ratio function.

5. The method according to claim 2, wherein the thinking mode data ratio function is an S-shaped function with an output value range between (0, 1).

6. The method according to claim 4, wherein the thinking mode data ratio function is an S-shaped function with an output value range between (0, 1).

7. The method according to claim 5, wherein the thinking mode data ratio function is constructed based on a Sigmoid function.

8. The method according to claim 6, wherein the thinking mode data ratio function is constructed based on a Sigmoid function.

9. An electronic device, comprising:
at least one processor; and
a memory communicatively connected to the at least one processor;
wherein the at least one processor is configured to:
adjust, based on training progress, a data ratio between thinking mode data and non-thinking mode data in training data;
obtain, based on adjusted training data, a first output sequence generated by a teacher model in the non-thinking mode and a second output sequence generated by the teacher model in the thinking mode;
obtain, based on the adjusted training data, a third output sequence generated by a student model in the non-thinking mode and a fourth output sequence generated by the student model in the thinking mode; and
train the student model based on the first output sequence, the second output sequence, the third output sequence, and the fourth output sequence.

10. The electronic device according to claim 9, wherein the at least one processor is further configured to:
adjust, based on a thinking mode data ratio function associated with the training progress, the data ratio between the thinking mode data and the non-thinking mode data in the training data, wherein a ratio of a current training step to a total number of training steps is determined as the training progress.

11. The electronic device according to claim 9, wherein the at least one processor is further configured to:
determine, based on the first output sequence and the third output sequence, a token-level knowledge distillation loss in the non-thinking mode;
determine, based on the second output sequence and the fourth output sequence, a token-level supervision loss in the thinking mode; and
determine a total loss based on the token-level knowledge distillation loss and the token-level supervision loss, and train the student model based on the total loss.

12. The electronic device according to claim 11, wherein the at least one processor is further configured to:
obtain the total loss by performing a weighted summation of the token-level knowledge distillation loss and the token-level supervision loss, wherein a weight of the token-level knowledge distillation loss and a weight of the token-level supervision loss are determined based on a thinking mode data ratio function.

13. The electronic device according to claim 10, wherein the thinking mode data ratio function is an S-shaped function with an output value range between (0, 1).

14. The electronic device according to claim 12, wherein the thinking mode data ratio function is an S-shaped function with an output value range between (0, 1).

15. The electronic device according to claim 13, wherein the thinking mode data ratio function is constructed based on a Sigmoid function.

16. The electronic device according to claim 14, wherein the thinking mode data ratio function is constructed based on a Sigmoid function.

17. A non-transitory computer-readable storage medium, storing computer instructions, wherein the computer instructions are configured to cause the computer to perform:
adjusting, based on training progress, a data ratio between thinking mode data and non-thinking mode data in training data;
obtaining, based on adjusted training data, a first output sequence generated by a teacher model in the non-thinking mode and a second output sequence generated by the teacher model in the thinking mode;
obtaining, based on the adjusted training data, a third output sequence generated by a student model in the non-thinking mode and a fourth output sequence generated by the student model in the thinking mode; and
training the student model based on the first output sequence, the second output sequence, the third output sequence, and the fourth output sequence.

18. The non-transitory computer-readable storage medium according to claim 17, wherein adjusting, based on the training progress, the data ratio between the thinking mode data and the non-thinking mode data in the training data comprises:
adjusting, based on a thinking mode data ratio function associated with the training progress, the data ratio between the thinking mode data and the non-thinking mode data in the training data, wherein a ratio of a current training step to a total number of training steps is determined as the training progress.

19. The non-transitory computer-readable storage medium according to claim 17, wherein training the student model based on the first output sequence, the second output sequence, the third output sequence, and the fourth output sequence comprises:
determining, based on the first output sequence and the third output sequence, a token-level knowledge distillation loss in the non-thinking mode;
determining, based on the second output sequence and the fourth output sequence, a token-level supervision loss in the thinking mode; and
determining a total loss based on the token-level knowledge distillation loss and the token-level supervision loss, and training the student model based on the total loss.

20. The non-transitory computer-readable storage medium according to claim 19, wherein determining the total loss based on the token-level knowledge distillation loss and the token-level supervision loss comprises:
obtaining the total loss by performing a weighted summation of the token-level knowledge distillation loss and the token-level supervision loss, wherein a weight of the token-level knowledge distillation loss and a weight of the token-level supervision loss are determined based on a thinking mode data ratio function.
